(19) United States
(12) Patent Application Publication
(10) Pub. No.: US 2018/0308099 A1
(43) Pub. Date: Oct. 25, 2018

(54) Fraud Detection Tool

(71) Applicant: Bank of America Corporation, Charlotte, NC (US)

(72) Inventors: Donald Francis Binns, Charlotte, NC (US); Ryan Gerald Evans, Charlotte, NC (US); Jill Kristen Otlowski, Charlotte, NC (US); Alan Andrew Hale, Woodstock, GA (US); Laura Marie Blattner-Confiado, Canton, GA (US)

(21) Appl. No.: 15/491,387

(22) Filed: Apr. 19, 2017

(51) Int. Cl. G06Q 20/40

(52) U.S. Cl. CPC G06Q 20/4016

(57) ABSTRACT

In an embodiment, a system contains a payee data database configured to store payee data that contains intended payee information and a fraud marker engine configured to determine a fraud marker based on the payee data, wherein the fraud marker identifies an activity including performing a transaction benefiting a payee account, wherein a plurality of payor accounts have, within a defined time frame, changed their intended payee information to include the payee account. The system also contains a fraud marker scoring engine that determines a fraud score for the fraud marker based a likelihood that the activity is fraudulent or a severity of the activity, and an activity monitoring and matching engine configured to monitor activity of a first payee account and a first payor account, determine that the monitored activity matches the fraud marker, and institute a block, cancellation, or hold on the monitored activity based on the fraud score.

### TECHNICAL FIELD

The present disclosure relates generally to network security, and particularly to fraud detection.

### BACKGROUND

Computer systems and networks are susceptible to fraud, and particularly to payee fraud. For example, induced phishing results in a seemingly legitimate transaction created by a legitimate payor to an illegitimate payee. A payee may fraudulently convince a payor to send electronic goods, currency, etc. over a computer network to the payee.

### SUMMARY

In an embodiment, a system contains a payee data database configured to store payee data that contains intended payee information of each of a plurality of payor accounts, a fraud marker engine configured to determine a fraud marker based on the payee data, wherein the fraud marker identifies an activity including performing a transaction benefiting a payee account, wherein the plurality of payor accounts have, within a defined time frame, changed their intended payee information to include the payee account, a fraud marker scoring engine, and an activity monitoring and matching engine. The fraud marker scoring engine determines a fraud score for the fraud marker based on at least one of a likelihood that the activity is fraudulent and a severity of the activity. The activity monitoring and matching engine is configured to monitor activity of at least one of a first payee account and a first payor account, determine that the monitored activity matches the fraud marker, and institute on the monitored activity, based on the fraud score, at least one of a block, including terminating the monitored activity, wherein the monitored activity is not yet completed, a cancellation, including reversing the monitored activity, wherein the monitored activity is completed, and a hold, including suspending the monitored activity.

In another embodiment, a system contains a fraud marker engine configured to determine a fraud marker based on payee data containing intended payee information of each of a plurality of payor accounts, wherein the fraud marker identifies an activity including performing a transaction benefiting a payee account, wherein the plurality of payor accounts have, within a defined time frame, changed their intended payee information to include the payee account. The system further contains a fraud marker scoring engine configured to determine a fraud score for the fraud marker based on at least one of a likelihood that the activity is fraudulent and a severity of the activity. Furthermore, the system includes an activity monitoring and matching engine configured to monitor activity of at least one of a first payee account and a first payor account, determine that the monitored activity matches the fraud marker, and institute, on the monitored activity, based on the fraud score, at least one of a block, including terminating the monitored activity, wherein the monitored activity is not yet completed, a cancellation, including reversing the monitored activity, wherein the monitored activity is completed, and a hold, including suspending the monitored activity.

In another embodiment, a method includes determining a fraud marker based on payee data that contains intended payee information of each of a plurality of payor accounts, wherein the fraud marker identifies an activity including performing a transaction benefiting a payee account, and wherein the plurality of payor accounts have, within a defined time frame, changed their intended payee information to include the payee account. The method further includes determining a fraud score for the fraud marker based on at least one of a likelihood that the activity is fraudulent and a severity of the activity, monitoring activity of at least one of a first payee account and a first payor account, and determining that the monitored activity matches the fraud marker. Moreover, the method includes instituting, on the monitored activity, based on the fraud score, at least one of a block, including terminating the monitored activity, wherein the monitored activity is not yet completed, a cancellation, including reversing the monitored activity, wherein the monitored activity is completed, and a hold, including suspending the monitored activity.

In accordance with the present disclosure, disadvantages and problems associated with network security systems, and particularly fraud detection and prevention systems seeking to detect and prevent payee fraud, may be reduced or eliminated, and one or more technical advantages may be realized. For example, some embodiments increase computer network security by better protecting against payee fraud, which is not easily prevented by conventional security measures, such as account names and passwords or other login information meant to protect the payor's account from outside intruders. Such embodiments also protect against payee accounts that have been taken over and initiate or receive transactions, particularly in instances where an enterprise does not have security control over the payee account.

Some embodiments of the present disclosure may increase the security of computer networks by increasing the ability of networks, enterprises, payors, and administrators to detect fraud, and especially fraud initiated by payees. Particular embodiments increase the security of networks by increasing the ability of networks, enterprises, payors, and administrators to prevent fraud, and especially fraud initiated by payees. More specifically, embodiments of the present disclosure target, detect, and/or prevent payee fraud induced by phishing scams and ploys. By increasing network security (including the security of individual accounts associated with the network), networks may function more for their intended purposes, and the improper access and use of the network may be reduced. Implementing certain embodiments of the present disclosure may also mean that fewer resources, both within the network and outside of the network (e.g., by enterprises and administrators) are required to devote to identification and/or remediation of network security vulnerabilities, and particularly payee induced fraud. In addition, by cataloging and storing data regarding payee accounts (which may not be accounts that are provided by the enterprise associated with the payor accounts—and thus the enterprise may not otherwise keep, create, or analyze such payee data), embodiments of the present disclosure collect, create, and/or use payee information that may not otherwise be used to prevent fraudulent activity that induces payors to make payments to fraudulent payees. Moreover, embodiments of the present disclosure transform payee information into fraud markers that can be used by computer networks and systems to increase network security by identifying potentially fraudulent activity. Thus, in sum, networks and computer systems may run more efficiently with reduced security vulnerability and reduced security incidents, and, as a result, the unconventional fraud detection tool addresses a problem necessarily rooted in computer network security systems and improves the underlying computer network security technology.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a fraud detection system, according to an example embodiment.

FIG. 2 illustrates a fraud detection tool of the fraud detection system of FIG. 1, according to an example embodiment.

FIG. 3 illustrates a method of detecting and preventing fraud using the fraud detection system of FIG. 1, according to an example embodiment.

### DETAILED DESCRIPTION

Computer systems and networks are susceptible to fraud, and particularly to payee fraud. For example, induced phishing results in a seemingly legitimate transaction created by a legitimate payor to an illegitimate payee. A payee may fraudulently convince a payor to send electronic goods, currency, etc. over a computer network to the payee. In such instances, identifying fraudulent activity, such as fraudulent transactions, between the payor and the payee over the computer network can be challenging, because the legitimate (and often willing) payor creates a seemingly legitimate transaction to the payee. Thus, traditional fraud detection measures are inadequate to detect these seemingly legitimate transactions from payors to payees, because, for example, the payor may be a rightful account holder and may have proper authorization to make the transaction at issue. However, even though the transaction was properly initiated, it may still have been fraudulently induced by the beneficiary of that payment (i.e., the payee). For example, a payee, as part of a scam, sets up a new account in a foreign country and runs a phishing scam via email to induce account owners (payors) to send the payee money for a product the payee never intends to deliver. Traditionally, such transactions are difficult to identify. Certain embodiments of the present disclosure can help detect such payee-induced fraud by, for example, using payee information (e.g., that the payee account was newly created, is based in a foreign country, is registered with a particular email address, etc.) to identify fraudulent transactions, even if the transactions were properly initiated by an authorized account holder.

This disclosure contemplates an unconventional fraud detection tool that can be used to identify and prevent or remediate payee induced fraud, such as induced phishing attacks (e.g., as in the example described above). For example, by creating a set of fraud markers (e.g., a set of rules with specific characteristics) that identify potentially fraudulent activity, network activity benefiting payees can be monitored and compared against the set of fraud markers to determine if a match is found. Matches may be found when the monitored activity is identified using a fraud marker, thus indicating that the activity is or may be fraudulent. In the event a match is found, a fraud score that rates the risk and/or severity of the activity can be determined, and appropriate action can be taken based on that fraud score. As a few examples, activity that has matched the fraud marker can be blocked, canceled, placed on hold, or allowed.

In accordance with the present disclosure, disadvantages and problems associated with network security systems, and particularly fraud detection and prevention systems seeking to detect and prevent payee fraud, may be reduced or eliminated, and one or more technical advantages may be realized. For example, some embodiments of the present disclosure may increase the security of computer networks by increasing the ability of networks, enterprises, payors, and administrators to detect fraud, and especially fraud initiated by payees. Particular embodiments increase the security of networks by increasing the ability of networks, enterprises, payors, and administrators to prevent fraud, and especially fraud initiated by payees. More specifically, embodiments of the present disclosure target, detect, and/or prevent payee fraud induced by phishing scams and ploys. In addition, by increasing network security (including the security of individual accounts associated with the network), networks may function more for their intended purposes, and the improper access and use of the network may be reduced. Implementing certain embodiments of the present disclosure may also mean that fewer resources, both within the network and outside of the network (e.g., by enterprises and administrators) are required to devote to identification and/or remediation of network security vulnerabilities, and particularly payee induced fraud. Moreover, enterprises providing payor accounts may not host or provide payee accounts (e.g., a payor can make a payment or otherwise send value to a remote account), and therefore such enterprises may not collect, create, or use payee information to reduce fraudulently induced transactions and other activity. Certain embodiments of the present disclosure, however, do make use of such payee information (payee data) to detect and prevent payee induced fraud. Moreover, some embodiments transform payee information into fraud markers that can be used by computer networks and systems to increase network security by identifying potentially fraudulent activity. Thus, in sum, networks and computer systems may run more efficiently with reduced security vulnerability and reduced security incidents, and, as a result, the unconventional fraud detection tool addresses a problem necessarily rooted in computer network security systems and improves the underlying computer network security technology.

Other technical advantages of the present disclosure will be readily apparent to one skilled in the art from the following figures, descriptions, and claims. Moreover, while specific advantages have been enumerated above, various embodiments may include all, some, or none of the enumerated advantages.

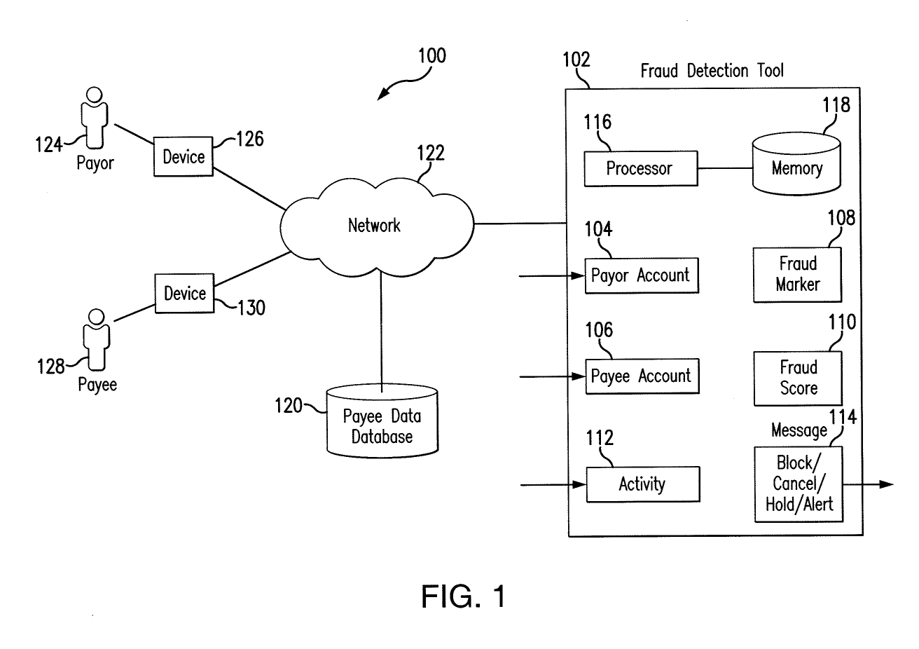

Embodiments of the present disclosure and its advantages may be best understood by referring to FIGS. 1-3, like numerals being used for like and corresponding parts of the various drawings.

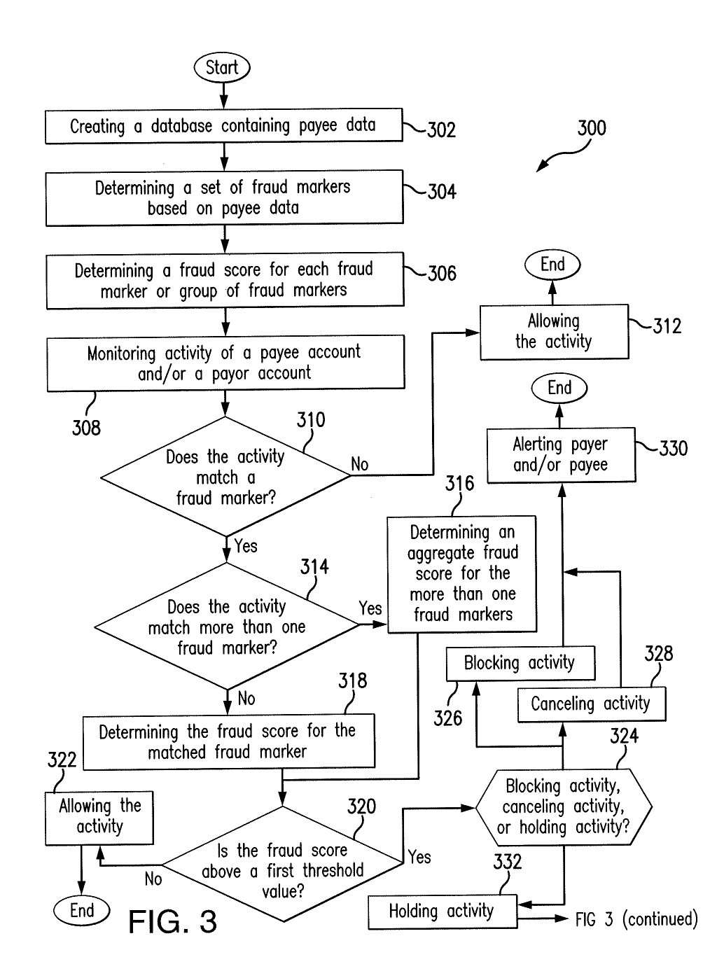

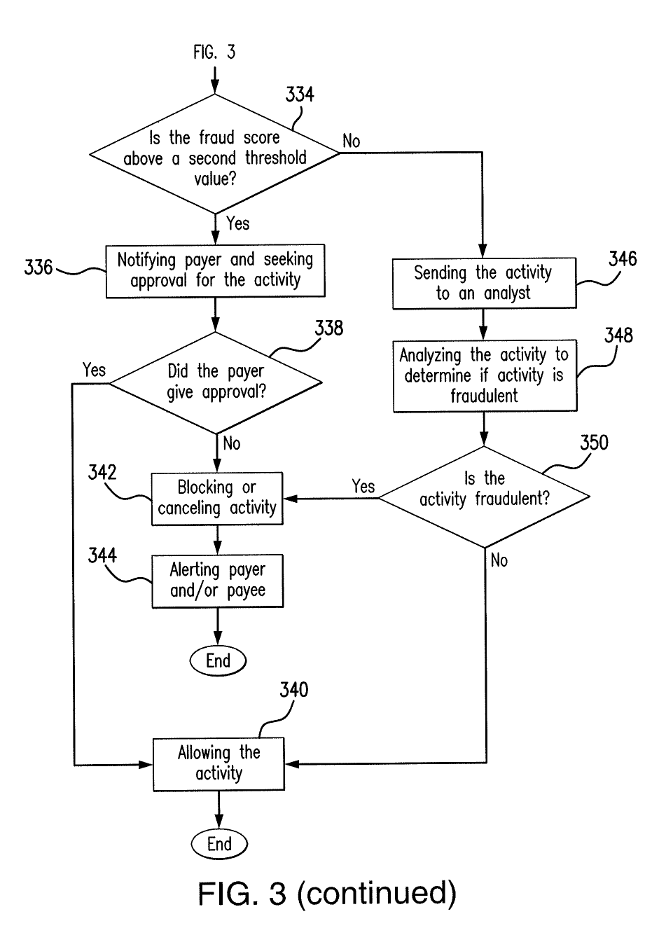

FIG. 1 illustrates a fraud detection system 100, according to an example embodiment. In general, fraud detection system 100 detects fraudulent activity occurring in computer systems, and more specifically detects fraudulent activity based on payee data, according to certain embodiments. The system of FIG. 1 includes fraud detection tool 102, which includes payor account 104 (or information therefrom), payee account 106 (or information therefrom), fraud marker 108, and fraud score 110. Fraud detection tool 102 also contains information regarding activity 112, message 114, processor 116, and memory 118. In addition, fraud detection system 100 includes, in some embodiments, payee data database 120, and network 122. In addition, a payor 124, via a payor device 126, connects to network 122 of system 100, such as the Internet and/or another public or private network in some embodiments. Likewise, a payee 128, via payee device 130, connects to network 122 of system 100 in certain embodiments. In particular embodiments, some or all of the system of FIG. 1 may carry out some or all of the steps of method 300 of FIG. 3.

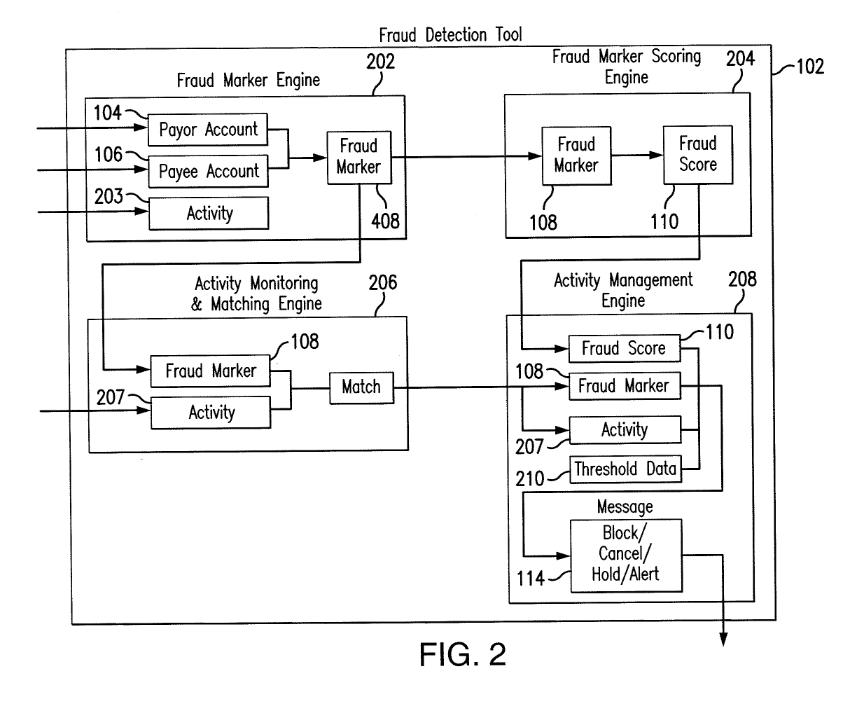

Fraud detection tool 102, according to some embodiments, detects fraudulent activity in computer systems, particularly based on payee data. In general, fraud detection tool 102 detects, prevents, or corrects certain fraudulent activity, particularly payee-induced fraudulent activity, based on payee data. The operation of fraud detection tool 102 is further described with regards to the included components, below, as well as in relation to in FIG. 2. Fraud detection tool 102, in some embodiments, is capable of communicating with other components of fraud detection system 100, including other components within fraud detection tool 102. Additionally, fraud detection tool 102 may issue messages or commands to other components and systems, for example, a system for which fraud detection tool 102 detects fraudulent activity. This disclosure contemplates fraud detection tool 102 being any appropriate device and/or software for sending and receiving communications over network 122.

Payor account 104 contains information about an account owned, operated, or held by payor 124 (which may be an entity or a person), according to some embodiments. For example, payor account 104 may contain a user ID, name, address, account numbers, transaction histories, account access histories, deposit histories, purchasing histories, and/or any other data about or describing payor 124 and its relationship with an enterprise such as the enterprise operating fraud detection system 100. In certain embodiments, payor 124 may, from payor account 104 initiate a transaction or other activity 112 benefiting payee account 106. Payor account 104 and data describing it (including data created for or by it) may be located on any component of fraud detection system 100 (e.g., payee data database 120) or on a different component not part of system 100 but accessible by system 100, such as an account database hosted by the enterprise operating fraud detection system 100. In certain embodiments, payor account 104 may exist within fraud detection tool 102, or fraud detection tool 102 may receive or store information about and/or from payor account 104.

Payee account 106 contains information about an account owned, operated, or held by payee 128 (which may be an entity or a person), according to some embodiments. For example, payee account 106 may contain a user ID, name, address, account numbers, transaction histories, account access histories, deposit histories, purchasing histories, and/or any other data about or describing payee 128 and its relationship with an enterprise such as the enterprise operating fraud detection system 100. In certain embodiments, payee 128 may, at payee account 106 be the recipient of a transaction or other activity 112 benefiting payee account 106, where for example the transaction or other activity is initiated by payor 124 via payor account 104. In some embodiments, payee account 106 is hosted or operated by a different enterprise than the enterprise controlling system 100. For example, payor 124 may have payor account 104 hosted or operated by the enterprise operating system 100 while payee account 106 is hosted or operated by another enterprise (e.g., a foreign account provider), entity, or merely payee 128 itself. Payee account 106 and data about or describing it may be located on any component of fraud detection system 100 (e.g., payee data database 120) or on a different component not part of system 100 but accessible by system 100, such as an account database hosted by the enterprise operating fraud detection system 100. In other embodiments, payee account 106 may be located on a different system, e.g., operated by a different enterprise. The example of FIG. 1 shows payee account as connected to network 122, though payee account may be located remotely via a different entity and accessed via the same or a different network. In certain embodiments, payee account 106 may exist within fraud detection tool 102, or fraud detection tool 102 may receive or store information about and/or from payee account 106.

Fraud marker 108 is a set of rules, patterns, or other information in a format that, when compared to ongoing activity (e.g., a transaction) can identify fraudulent, or likely fraudulent activity. For example, if it is determined that a certain payee account has been created recently (e.g., within the past month or any other suitable period of time) and that a number of different payors (e.g., more than 10) are sending first-time payments to the payee within a certain time period, this may be an indicator of payee induced fraud. For such activity, a fraud marker (which may be created by or used by or in conjunction with other components of system 100) can assist with identifying fraudulent or potentially fraudulent activity of the type described in, or identified by, the fraud marker. As examples, a fraud marker may identify patterns in monitored activity, contain rules that, when satisfied by monitored activity, denote potentially fraudulent activity, etc. Certain examples of fraud markers for fraudulent activity (particularly payee induced fraud) are described with regard to FIG. 3, such as at step 304.

Fraud score 110 generally represents a likelihood that the activity is fraudulent and/or a severity of the activity identified by the fraud markers (e.g., fraud marker 108), according to some embodiments. For example, a transaction for the purchase of a car may have a higher severity than a transaction to pay a water bill, and a $10,000 transaction may have a higher severity than a $300 transaction. In some embodiments, severity indicates or measures the amount of harm that may occur if the activity at issue is fraudulent. Fraud scores 110 may, for example, be based on fraud markers 108 and/or activity identified by fraud markers 108. In certain embodiments, fraud score 110 may be on any suitable scale, for example, from 0 (indicating no fraud risk) to 100 (indicating a most severe fraud risk and/or a fraud risk that is certain). In some embodiments, a fraud score 110 may represent a single fraud markers or one or more groups of fraud markers. In some embodiments, fraud markers 108 may have more than one fraud score. While this disclosure discusses example fraud scores, any suitable fraud score is contemplated.

Activity 112 is any activity that can be intercepted by, described to, or otherwise monitored by system 100, according to certain embodiments. For example, system 100 may receive information about activity between payors and payees (including but not limited to, payor 124 and/or payee 128), as well as information about activity between payor accounts and payee accounts (including but not limited to, payor account 104 and/or payee account 106). Activity 112 may contain or describe transactions between payors and payees, changes to payor account data (e.g., changes to payee information in payor account data), changes to payee account data, etc., according to certain embodiments. In some embodiments, activity 112 contains activity 203 and activity 207 of FIG. 2. For example, activity 112 may include activity 203 that fraud marker engine 202 uses to determine one or more fraud markers 108, as well as monitored activity 207 that activity monitoring engine 206 uses to determine that monitored activity 207 matches one or more fraud markers 108. In particular embodiments, activity 203 may occur earlier in time such that a fraud marker 108 can be created and used by activity monitoring engine 206 to identify activity 207, which may occur after (later in time than) activity 203. Any suitable activity is contemplated for activity 112.

Message 114 is, generally, an action taken by fraud detection tool 102 after monitored activity (e.g., activity 207 of FIG. 2) has been found to match a fraud marker 108 having a certain fraud score 110, according to certain embodiments. In particular embodiments, message 114 is an action/message/command to other components of system 100 (or other systems, e.g., a system hosting payee account 106 when an enterprise operating system 100 does not host payee account 106) to effect the desired message 114 (e.g., a block, a cancellation, a hold, or an alert regarding monitored activity 207 of FIG. 2).

Payee data database 120 contains payee data, in some embodiments. For example, payee data database 120 stores account information about particular payees and information about payees taken from activity (e.g., activity 206, such as transactions) initiated by payors. In certain embodiments, an enterprise operating system 100 may not host or operate payee account 106, and thus can store information about payees in payee data database 120. Payee data database 120 stores, in some embodiments, data related to all transactions previously identified as fraudulent or potentially fraudulent. In embodiments where an enterprise operating system 100 does host or operate payee account 106, it may still host payee data (and including, e.g., some or all payee account information) in payee data database 120. Payee data database 120 is contemplated to store any suitable payee account information and/or payor account information.

Payee data database 120, in general, is a data/memory storage that stores data in or for fraud detection system 100. In certain embodiments, payee data database 120 may not be permanent storage, but rather temporary storage, such as a data cache, though payee data database 120 may be any suitable type of storage, including permanent storage, cloud storage, etc. In some embodiments, payee data database 120 stores some or all of the data used by fraud detection system 100 to operate as described in this disclosure. Payee data database may be a separate storage, as shown in the example of FIG. 1, or it may be incorporated into any other component of system 100 (e.g., within memory 118), or any component outside of system 100.

Processor 116 (which may be more than one processor in one or more components) is any electronic circuitry, including, but not limited to microprocessors, application specific integrated circuits (ASIC), application specific instruction set processor (ASIP), and/or state machines, that communicatively couples to memory 118 and controls the operation of fraud identification system 100, or components thereof. Processor 116 may be 8-bit, 16-bit, 32-bit, 64-bit or of any other suitable architecture. Processor 116 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 116 may include other hardware and software that operates to control and process information. Processor 116 executes software stored on memory to perform any of the functions described herein. Processor 116 controls the operation and administration of fraud identification system 100, or components thereof, by processing information received from, e.g., network 122 or any component of system 100. Processor 116 may be a programmable logic device, a microcontroller, a microprocessor, any suitable processing device, or any suitable combination of the preceding. Processor 116 is not limited to a single processing device and may encompass multiple processing devices.

Memory 118 (which may be more than one memory in one or more components and may, in some embodiments, include payee data database 120 or portions thereof) may store, either permanently or temporarily, data, operational software, or other information for processor 116. Memory 118 may include any one or a combination of volatile or non-volatile local or remote devices suitable for storing information. For example, memory 118 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 118, a disk, a CD, or a flash drive. In particular embodiments, the software may include an application executable by processor 116 to perform one or more of the functions described herein.

Payor device 126 and payee device 130 generally allow payor 124 and payee 128, respectively, to access payor account 104 and payee account 106, respectively, over any suitable network, according to example embodiments. In some embodiments, payor device 126 and payee device 130 generally allow payor 124 and payee 128, respectively, to access components of system 100, for example, through network 122. In some embodiments, payor device 126 and payee device 130 connect directly to network 122. In some embodiments, payor device 126 and payee device 130 assist with authenticating a user (e.g. payor 124 and payee 128) after the user has registered with an enterprise hosting or operating payor account 104 or payee account 106. In some embodiments, payor device 126 and payee device 130 display alerts to payor 124 and/or payee 128, e.g., alerts regarding fraudulent activity affecting (or that has or could affect) the payor's 124 or payee's 128 account, or fraudulent activity that could or has affected other payors and payees that could impact (at the moment or in the future) payor 124 and payee 128. Payor device 126 and payee device 130 may function as described elsewhere in this disclosure, for example, with regard to FIG. 3.

Payor device 126 and payee device 130 are any device capable of communicating with other components of system 100. For example, payor device 126 and payee device 130 may execute applications that use information stored on memory 118 or network 122. Payor device 126 and payee device 130 may also write data to memory 118 or network 122. Additionally, payor device 126 and payee device 130 may issue messages or commands to other devices and systems, for example, one or more components of system 100. This disclosure contemplates payor device 126 and payee device 130 being any appropriate device for sending and receiving communications with system 100. As an example and not by way of limitation, payor device 126 and payee device 130 may each be a computer, server, a laptop, a wireless or cellular telephone, an electronic notebook, a personal digital assistant, a tablet, or any other device capable of receiving, processing, storing, and/or communicating information with other components of fraud detection system 100. Payor device 126 and payee device 130 may each also include a user interface, such as a display, a microphone, keypad, or other appropriate terminal equipment usable by payor 124 and payee 128, respectively. In some embodiments, an application executed by payor device 126 and/or payee device 130 may perform the functions described herein.

Network 122 connects certain elements of this disclosure, in some embodiments. For example, network 122 may connect components of fraud detection system 100 together to allow or assist with the operation of system 100. In certain embodiments, network 122 may be secure or unsecure. In some embodiments, the components of system 100 may each be on the same network, which may be network 122. In other embodiments, one or more components of system 100 may be on separate networks, one or none of which is network 122, and may communicate with each other using any suitable means. Network 122 may be any local or wide area network that is suitable for use in or with this disclosure, for example: the Internet, a local area network, a private network, a cellular network, etc.

Network 122 facilitates communication between and amongst the various components of system 100. This disclosure contemplates network 122 being any suitable network operable to facilitate communication between the components of fraud detection system 100. Network 122 may include any interconnecting system capable of transmitting audio, video, signals, data, messages, or any combination of the preceding. Network 122 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

System 100, in some embodiments, may increase the security of computer networks by increasing the ability of networks, enterprises, payors, and administrators to detect fraud, and especially fraud initiated by payees. More specifically, embodiments of system 100 target, detect, and/or prevent payee fraud induced by phishing scams and ploys. In addition, by increasing network security (including the security of individual accounts associated with the network), networks may function more for their intended purposes, and the improper access and use of the network may be reduced. Implementing certain embodiments of system 100 may also mean that fewer resources, both within the network and outside of the network (e.g., by enterprises and administrators) are required to devote to identification and/or remediation of network security vulnerabilities, and particularly payee induced fraud. Moreover, enterprises providing payor accounts may not host or provide payee accounts (e.g., a payor can make a payment or otherwise send value to a remote account), and therefore such enterprises may not collect, create, or use payee information to reduce fraudulently induced transactions and other activity. Certain embodiments of system 100, however, do make use of such payee information (payee data) to detect and prevent payee induced fraud. Moreover, some embodiments transform payee information into fraud markers that can be used by computer networks and systems to increase network security by identifying potentially fraudulent activity. Thus, in sum, networks and computer systems may run more efficiently with reduced security vulnerability and reduced security incidents, and, as a result, system 100 addresses a problem necessarily rooted in computer network security systems and improves the underlying computer network security technology.

While certain components of certain devices are shown in FIG. 1 in certain configurations, other suitable components, devices, and configurations are contemplated in this disclosure.

FIG. 2 illustrates a fraud detection tool 102, according to an example embodiment. In general, fraud detection tool 102 is implemented to detect fraudulent activity occurring in computer systems, and more specifically provides functionality for fraud detection system 100 to detect fraudulent activity based on payee data, according to certain embodiments. Fraud detection tool 102 includes fraud marker engine 202, fraud marker scoring engine 204, and activity monitoring and matching engine (“activity monitoring engine”) 206. Furthermore, fraud detection tool 102 includes an activity management engine 208 that contains threshold data 210. In certain embodiments, some or all of fraud detection tool 102 may carry out some or all of the steps of method 300 of FIG. 3.

Fraud marker engine 202 generally creates and stores fraud markers (e.g., fraud marker 108), in certain embodiments. In particular embodiments, fraud marker engine 202 assists with analyzing activity 203 between payors and payees (which could be some or all of activity 112, e.g., activity occurring prior to activity 207, on a different network, etc.) to determine fraud markers 108 that can identify fraudulent or likely fraudulent activity, e.g., payee induced fraud. Fraud marker engine 202 may also use information (located in, e.g., payee data database 120 and/or memory 118) from and/or about a payor account (e.g., 104 or others) and/or a payee account (e.g., 106 or others) in its analysis to determine fraud markers. Fraud marker engine 202 may function as described elsewhere in this disclosure, for example, with regard to FIG. 3. In some embodiments, fraud markers are rules, patterns, or other information in a format that, when compared to ongoing activity (e.g., a transaction) can identify fraudulent, or likely fraudulent activity. For example, if it is determined that a certain payee account has been created recently (e.g., within the past month or any other suitable period of time) and that a number of different payors (e.g., more than 10) are sending first-time payments to the payee within a certain time period, this may be an indicator of payee induced fraud. For such activity, fraud marker engine 202 may in some embodiments create a fraud marker (which may be used by or in conjunction with other components of system 100) that can assist with identifying fraudulent or potentially fraudulent activity of the type described in, or identified by, the fraud marker. As examples, a fraud marker may identify patterns in monitored activity, contain rules that, when satisfied by monitored activity, denote potentially fraudulent activity, etc. Certain examples of fraud markers for fraudulent activity (particularly payee induced fraud) are described with regard to FIG. 3, such as at step 304. Fraud marker engine 202 can, in certain embodiments, perform any function of system 100 or be located within any component of system 100.

Fraud marker engine 202 also, in certain embodiments, has the ability to communicate with other components of system 100, either directly or indirectly, e.g., via a network, e.g., network 122. In some embodiments, fraud marker engine 202 receives information from system 100 or any other suitable source (monitored activity, databases, other networks, other enterprises that do not operate or control system 100, etc.). Such information, in example embodiments, may be from and/or about activity 203 between payors and payees (which could be some or all of activity 112, e.g., activity occurring prior to activity 112, on a different network, etc.), a payor account (e.g., 104 or others), and/or a payee account (e.g., 106 or others), which fraud marker engine 202 may use in its analysis to determine fraud markers. As an additional example, fraud marker engine 202 may send one or more determined fraud markers 108 to fraud marker scoring engine 204, activity monitoring and matching engine 206, and/or activity management engine 208.

Fraud marker scoring engine 204 generally determines and stores fraud scores (e.g., fraud score 110) for individual fraud markers and/or groups of fraud markers, in certain embodiments. In particular embodiments, fraud marker scoring engine 204 analyzes fraud markers (e.g., fraud marker 108 from fraud marker engine 202), or activity related to (described by) fraud markers, to determine fraud scores that, for example, represent a likelihood that the activity is fraudulent and/or a severity of the activity that matches the fraud markers. For example, a transaction for the purchase of a car may have a higher severity than a transaction to pay a water bill, and a $10,000 transaction may have a higher severity than a $300 transaction. In some embodiments, severity indicates or measures the amount of harm that may occur if the activity at issue is fraudulent. Fraud marker scoring engine 204 may function as described elsewhere in this disclosure, for example, with regard to FIG. 3. Fraud marker scoring engine 204 may, for example, base fraud scores on fraud markers and/or activity matching fraud markers determined by fraud marker engine 202. In certain embodiments, fraud marker scoring engine 204 may create a fraud score on any suitable scale, for example from 0 (indicating no fraud risk) to 100 (indicating a most severe fraud risk and/or a fraud risk that is certain). In some embodiments, fraud marker scoring engine 204 may determine scores for single fraud markers or groups of fraud markers. In some embodiments, fraud markers may have more than one fraud score based on one or more sets of criteria or rules (e.g., policies) used by fraud marker scoring engine 204. The sets of criteria or rules may be created automatically by programs, input from administrators of system 100, or users of accounts serviced by system 100. Fraud marker scoring engine 204 can, in certain embodiments, perform any function of system 100 or be located within any component of system 100.

Fraud marker scoring engine 204 also, in certain embodiments, has the ability to communicate with other components of system 100, either directly or indirectly, e.g., via a network, e.g., network 122. In some embodiments, fraud marker scoring engine 204 receives information from system 100 or any other suitable source (e.g., fraud marker engine 202, monitored activity, etc.), which it may use to determine one or more fraud scores 110. As an additional example, fraud marker engine 202 may send one or more determined fraud scores 110 and/or fraud markers 108 to activity monitoring and matching engine 206 and/or activity management engine 208.

Activity monitoring and matching engine (“activity monitoring engine”) 206 generally monitors activity 207 of or affecting payor and/or payee accounts and determines when certain activity matches one or more fraud markers, in certain embodiments. In particular embodiments, activity monitoring engine 206 monitors activity 207 of or affecting (or monitored by) components of system 100, for example, activity, such as transactions, initiated by payors or payees or between payors and payees monitored by (or whose accounts or activity therefrom are monitored by) system 100 (e.g., payor 124 or payee 128). Activity 207 could be some or all of activity 112, e.g., activity occurring after activity 203, on a different network, etc.). Any amount of activity 207 of payors or payees, whether or not accounts owned by such payor or payees are serviced by system 100, may be monitored by activity monitoring engine 206. As one example, activity monitoring engine 206 monitors activity 207 between payor 124, whose payor account 104 is hosted by an enterprise operating system 100, and payee 128, whose payee account may or may not be hosted by the enterprise operating system 100. In addition, activity monitoring engine 206 compares the activity it monitors with fraud markers created by, e.g., fraud marker engine 202 to determine if the monitored activity matches one or more fraud markers, in some embodiments. In certain embodiments, activity monitoring engine 206 receives and stores some or all of the fraud markers created by fraud marker engine 202 and uses them to determine matches against the monitored activity 207. Activity monitoring engine 206 may function as described elsewhere in this disclosure, for example, with regard to FIG. 3. Activity monitoring engine 206 can, in certain embodiments, perform any function of system 100 or be located within any component of system 100.

Activity monitoring engine 206 also, in certain embodiments, has the ability to communicate with other components of system 100, either directly or indirectly, e.g., via a network, e.g., network 122. In some embodiments, activity monitoring engine 206 receives information from system 100 or any other suitable source (e.g., fraud marker engine 202, fraud marker scoring engine 204, network 122, etc.). Such information, in example embodiments, may be from and/or about activity 207 between payors and payees (which could be some or all of activity 112, e.g., activity occurring after activity 203, on a different network, etc.), and activity monitoring engine 206 may receive one or more fraud markers 108. In certain embodiments, activity monitoring engine 206 may use this information (e.g., regarding activity 207 and fraud marker 108) in its analysis to determine whether a monitored activity (207) matches a fraud marker (108). As an additional example, activity monitoring engine 206 may send activity 207 that matches one or more fraud markers 108, as well as such fraud marker(s) 108, to activity management engine 208.

Activity management engine 208 generally manages activity and determines how activity is treated when activity matches one or more fraud markers, in certain embodiments. In particular embodiments, activity management engine 208 is notified by other components of system 100 (e.g., activity monitoring engine 206) when activity (e.g., activity 207) monitored by activity monitoring engine 206 matches with one or more fraud markers. For example, once activity monitoring engine 206 makes a match, it sends information regarding the activity (207) to activity management engine 208. In addition, the one or more fraud markers 108 and their fraud scores 110 may also be sent to activity management engine 208 by other components of system 100 (or activity management engine 208 may request such fraud markers and/or activity information from other components of system 100, e.g., fraud marker engine 202, fraud marker scoring engine 204, activity monitoring and matching engine 206, payee data database, memory 118, etc.). In certain embodiments, activity management engine 208 compares the one or more fraud scores 110 against one or more threshold values to determine how the monitored (and matched) activity should be treated. In particular embodiments, threshold values are stored and/or determined based on data stored in threshold data 210. Further examples of activity management engine 208 determining/comparing relevant fraud scores to threshold values are described with regard to FIG. 3. Activity management engine 208 may process the one or more fraud scores 110 before comparing them to a threshold value in any suitable way in some embodiments, for example by scaling the fraud scores, averaging them, processing them via an algorithm, etc. In certain embodiments, activity management engine 208 determines how to manage the monitored and matched activity 207. For example, activity management engine 208 may determine a message 114, an action/message/command to block, cancel, or place on hold the activity 207 or any other related activity (e.g., activity benefiting a suspected fraudulent payee, activity initiated by a particular payor, all payors, etc.). In some embodiments, activity management engine 208 issues a message 114 containing alerts to payors, payees, or any other suitable recipient regarding the monitored activity and/or the actions taken by activity management engine 208. In some embodiments, activity management engine 208 may operate based on one or more sets of criteria or rules (e.g., policies) used by activity management engine 208. The sets of criteria or rules may be created automatically by programs, input from administrators of system 100, or users of accounts serviced by system 100. For example, once a fraudulent payee account or payee is determined, payors that are involved, payors that likely will be involved, or payors that could be involved with the fraudulent payee account or payor may be alerted. In some embodiments, an alert regarding detected or suspected fraud could go to some or all payors and/or payees (or their accounts), e.g. monitored, operated, or hosted by system 100. Further examples of activity management engine 208 managing monitored activity are described with regard to FIG. 3. Activity management engine 208 can, in certain embodiments, perform any function of system 100 or be located within any component of system 100.

Activity management engine 208 also, in certain embodiments, has the ability to communicate with other components of system 100, either directly or indirectly, e.g., via a network, e.g., network 122. In some embodiments, activity management engine 208 receives information from system 100 or any other suitable source (fraud marker engine 202, fraud marker scoring engine 204, activity monitoring and matching engine 206, payee data database 120, etc.). Such information, in example embodiments, may be from and/or about activity 207 between payors and payees (which could be some or all of activity 112, e.g., activity occurring after activity 112, on a different network, etc.), one or more fraud markers 108 matching monitored activity 207 and their fraud score(s) 110, and threshold data 210. Activity management engine 208 may use such information in its analysis to determine a particular message 114, according to certain embodiments. As an additional example, activity management engine 208 may send a determined message 114 to other components of system 100 or other systems to effect the desired output (e.g., a block, cancellation, hold, or alert regarding monitored activity 207).

Fraud detection tool 102, in some embodiments, contain threshold data 210 (e.g., in memory 118, an engine 202, 204, 206, and 208, etc.). Threshold data 210 contains data related to one or more thresholds related to fraud scores 110 (e.g., fraud scores created by fraud marker scoring engine 204). As an example, threshold data 210 may contain a first threshold and a second threshold, where if a fraud score 110 related to an activity (e.g., 207) is below the first threshold then the activity is allowed, if the fraud score 110 is above the second threshold then the activity is blocked or canceled, and if the fraud score 110 is between the first and second thresholds then the activity is placed on hold. Any number of thresholds related to or based on any suitable information is contemplated in this disclosure. In certain embodiments, the threshold data may contain data described with regard to FIG. 3 and used by any suitable component of system 100. In certain embodiments, threshold data may be located on payee data database 120, memory 118 or in any other suitable storage, e.g. storage accessible via network 122.

Fraud detection tool 102, in some embodiments, may increase the security of computer networks by increasing the ability of networks, enterprises, payors, and administrators to detect fraud, and especially fraud initiated by payees. More specifically, embodiments of fraud detection tool 102 target, detect, and/or prevent payee fraud induced by phishing scams and ploys. In addition, by increasing network security (including the security of individual accounts associated with the network), networks may function more for their intended purposes, and the improper access and use of the network may be reduced. Implementing certain embodiments of fraud detection tool 102 may also mean that fewer resources, both within the network and outside of the network (e.g., by enterprises and administrators) are required to devote to identification and/or remediation of network security vulnerabilities, and particularly payee induced fraud. Moreover, some embodiments transform payee information into fraud markers that can be used by computer networks and systems to increase network security by identifying potentially fraudulent activity. Thus, in sum, networks and computer systems may run more efficiently with reduced security vulnerability and reduced security incidents, and, as a result, fraud detection tool 102 addresses a problem necessarily rooted in computer network security systems and improves the underlying computer network security technology.

While certain components of certain devices are shown in FIG. 2 in certain configurations, other suitable components, devices, and configurations are contemplated in this disclosure.

FIG. 3 illustrates a method 300 of detecting and preventing fraud using a fraud detection system, according to an example embodiment. In certain embodiments, some or all of the elements of fraud detection system 100 perform some or all of the steps of method 300. Method 300 contains steps 302 through step 350.

Step 302 includes creating a database containing payee data. As examples, the data may include payee data entered by a payor for a transaction, payee data that identifies a particular payee operating a payee account, payee data entered by a payee as account information such as an address, account number, telephone number, etc. In certain embodiments, the database may also contain data describing, (or created by or for) payor accounts, or any other suitable data, such as data related to all transactions previously identified as fraudulent or potentially fraudulent. In some embodiments, the database may be payee data database 120 or similar to payee data database 120.

Step 304 includes determining a set of fraud markers based on payee data. For example, fraud markers may, in some embodiments, identify certain payee accounts and/or transaction activity to the payee accounts. In certain embodiments, determining a set of fraud markers includes creating one or more rules or identifiable patterns that identify a certain type of fraudulent activity, e.g., activity of or affecting a payee (or payor or other entities, as needed). Determining a set of fraud markers may also include collecting and analyzing various types of data, such as payee data, payor data (including payor-entered payee data/intended payee information), or any other relevant data. As an example, a fraud marker is based on payee data that includes intended payee information, wherein the fraud marker identifies an activity including performing a transaction benefiting a payee account, wherein multiple payor accounts have, within a defined time frame (e.g., a set amount of time—any suitable amount of time can be defined), changed their intended payee information to include the payee account. Any example fraud marker discussed in this disclosure, and any other suitable fraud marker, may be part of a fraud marker. For example, different concepts for different fraud markers may be combined into a single (or multiple fraud markers) any suitable number or manner.

As one example, a fraud marker may be determined by collecting data regarding many or all payees and reviewing the payee data to identify patterns shared between known fraudulent payee accounts and/or known fraudulent transactions. Another example fraud marker may identify particular email addresses used by known or suspected fraudulent payees, such that transactions to or involving accounts using that email address are identified. Similarly, an example fraud marker may identify particular address or account number, such as payee addresses or account numbers used by known or suspected fraudulent payees, such that transactions to or involving accounts using that email address are identified.

Another example fraud marker may identify newly-opened accounts, such as newly-opened payee accounts, which may identify potentially fraudulent accounts and/or payees. Yet another fraud marker may identify transaction characteristics, or other activity, new to a particular payee account, for example, new (e.g., first time) international transfers to the account (e.g., from a payor in a first country to a payee in a second country, or from a payor account based in a first country to a payee account based in a second country), new payor(s) to the account, a new pattern of activity of or affecting the account, changing payee data from domestic information to international information (e.g., an international address, account number, phone number, IP address, etc.), etc. In particular embodiments, payee data indicates that a payee account is based in a particular country that is different from the country in which the payor account is based, which may also be identified by a fraud marker. In some embodiments, payee data may contain information that represents domestic information, where the information indicates that payee account (and/or the payee operating the payee account) is located in, or hosted by an entity based in, the same country as the payor account (and/or the payor operating the payor account). For example, if a payor with an account based in the United States makes payments to a payee account having a United States telephone number as the registered telephone number in the payee data, the United States telephone number in the payee data would be an example of domestic information. If the payee data is changed (e.g., in the payor account or the payee account) such that the United States telephone number is changed to a Brazilian telephone number, then the Brazilian telephone number would be an example of international information in the payee data, and would indicate that the payee account is based in a foreign country (here, Brazil). In some embodiments, payee data may contain information that represents domestic information, where the information indicates that payee account (and/or the payee operating the payee account) is located in, or hosted by an entity based in, the same country (1) as when the payee account was created or (2) as when the payee account was first monitored, identified, etc. (e.g., by system 100). For example, if payee data of a particular payee account has a French telephone number registered with the payee account and the account has had a French telephone number registered with it since the account was first identified, monitored, or created, then the French telephone number is domestic information. If the payee data is changed (e.g., in the payor account or the payee account) such that the French telephone number is changed to an Australian telephone number (whether or not a payor making a transaction to the payee is also Australian), then the Australian telephone number would be an example of international information in the payee data. Any suitable information in payee data may be changed from domestic to international, such as the payee's address, a country or country code used by the payee account, payee's phone number, payee's account information (e.g., the institution/enterprise/entity hosting the account and where it is based), IP address, etc. In certain embodiments, domestic or international information may be contained in payee information that is located in payor accounts (and modified by payors in payor accounts, e.g., when inputting information about an intended payee) and/or in payee accounts (and modified by payees in payee accounts). Such actions, or any combination thereof, may be identified by a fraud marker in some embodiments.

An example fraud marker may also identify potentially fraudulent accounts or activity by comparing balances. In some embodiments, a fraud marker may identify consumer accounts (payee or payor) that have activity outside of the normal transaction pattern for a group consumer accounts or for that particular consumer account. As one example, a payee account is a consumer account that usually (over a certain period of time historically) receives $500 per month from a certain payor. Then, at some point there is a $10,000 transfer from the payor to the payee, which may indicate a potentially fraudulent transaction was initiated either by the payor or the payee. Balances may be compared based on any suitable class of payor or payee accounts, or on the history of one or more specific accounts.

Another example fraud marker may identify a payee account that initiates activity with a payor that is out of the ordinary pattern for the payee, the payor, or a group or class containing either, where the payor allows the payee to extract value (e.g., initiate transactions) from the payor's account.

Yet another example fraud marker may identify activity occurring when multiple payors (of any suitable number, e.g., 2, 5, 10, 100, 300, 1000, etc.) direct payments (of a similar size, kind (e.g., digital good, bitcoin, online order for goods or services, etc.), or within a certain time period) to a single payee or group of payees, which may be one or more newly created payee accounts (1 day, 1 month, 3 months, or any other suitable age) or one or more existing payee accounts never before used by the payor accounts. Similarly, an example fraud marker may identify activity related to instances where multiple payor accounts change account information regarding an intended payee (e.g., an intended beneficiary of the payor), which may be known as intended payee information, within the same time frame to identify or otherwise benefit the same payee account or to identify or otherwise benefit a new payee account (which may or may not be the same payee account for each payor). In another example, a fraud marker may identify activity related to instances where a number of payors (5, 10, 20, 100, or any suitable number) have changed multiple accounts of or for paying vendors to the same payee account (e.g., changed intended payee information), which may be a newly created payee account or an existing payee account never before used by the vendor accounts and/or payor accounts.

An example fraud marker may also identify activity related to a payee account that changes account information to a different hosting enterprise (e.g., an online payment service, financial institution, crowdfunding service, etc.), and then, in certain embodiments, receives a transfer or other beneficial activity in an amount (or of a value) above a threshold. For example, a change in financial information of a payee account followed by an uncharacteristically large transfer to that account. Such thresholds may be determined in any suitable manner, such as based on the payee account's activity history (e.g., 100% larger than any prior transfer in the past 6 months), standard criteria covering one or more than one account (e.g., any transfer over $5,000), or any other criteria or combination of criteria.

Another example fraud marker may identify activity related to instances where certain payor accounts change information regarding an intended payee, which may be known as intended payee information, (e.g., an intended beneficiary of the payor) while certain other payor accounts do not change their payee information, or do not change it in the same way. As one example, a fraud marker may identify when an entity having five accounts changes, for only four of the five accounts, vendor (payee) information for a particular service or product (e.g., IT services, a mobile phone plan, etc., food) that is related to all of the five accounts. The fact that only one account is not changed may be a flag for the other four, though any suitable variation of these numbers is contemplated (e.g., only one of 10 related accounts has vendor/payee information that is changed, etc.)

Yet another example fraud marker may identify activity related to instances where payee information provided by a payor does not match payee information provided by the payee. For example, the payee address, name, account history, identifier number, country, phone number, etc. may be different between payor-provided and payee-provided payee information. Similarly, an example fraud marker may identify activity where payors and payees (or payor and payee accounts) provide inconsistent information regarding a transaction, such as date, amount, kind (money, services, goods, bitcoin), or any other transaction information.

In certain embodiments, any fraud marker may identify or be otherwise based on payees, which can hold or operate one or more payee accounts (e.g., one payee has many different accounts), and/or payee accounts, which can also be held or operated by one or more payees (e.g, multiple people or entities have a single account, or vice versa).

Step 306 includes determining a fraud score for each fraud marker or group of fraud markers. In certain embodiments, a particular marker may have a score indicating or based on the likelihood that an activity (identified by one or more fraud markers) is fraudulent (fraud risk) and/or the severity of the fraudulent/potentially fraudulent activity. As a particular example, step 306 includes determining a fraud score for the fraud marker based on at least one of a likelihood that the activity is fraudulent and a severity of the activity. This fraud score may be on any suitable scale, for example from 0 (indicating no fraud risk) to 100 (indicating a most severe fraud risk or a fraud risk that is certain). For example, activity involving a newly-created payee account may have a fraud score of 15, and activity involving a first-time transaction with a foreign-based payee account (or payee) may have a fraud score of a 32. Fraud markers may be given any suitable fraud score.

Step 308 includes monitoring activity of a payee account and/or a payor account. For example, such activity can include modifying payee account information, monitoring payors modifying recipient/beneficiary/payee information to contain certain payee information (e.g., many payors add or change a recipient to be a particular payor within a certain time frame). As another example, the activity being monitored may be one or more transactions to one or more payees. As yet another example, the activity being monitored may be a payor making payments or certain types of payments (amounts, international, etc.) to a payee in a way that is outside the usual pattern of activity of the payor. In some embodiments, step 308 includes monitoring activity of a payee account and/or a payor account, which may include changes to either or both accounts, transactions to or from either or both accounts, etc. In certain embodiments, activity can be monitored related any or all of the fraud markers described in step 304, or any other suitable activity that can assist with identifying fraudulent actions or activity.

Step 310 includes determining whether the monitored activity matches a fraud marker. In certain embodiments, the activity monitored in step 308 is compared to the set of fraud markers (e.g., a set of rules that identify fraudulent activity may be run against the monitored activity). For example, if a fraud marker identifies a payee receiving more than 20 first-time transactions from payors within a certain time frame (e.g., 3 days) matches with monitored activity, then a match has been made. If there is no match, method 300 proceeds to step 312. If there is a match, method 300 proceeds to step 314

Step 312 includes allowing the activity. In certain embodiments, such activity is likely not fraudulent because no match between the activity and a fraud marker was made. Thus, this non-fraudulent activity, or at least undetected fraudulent activity, is permitted to occur/continue in some embodiments.

Step 314 includes determining whether the monitored activity matches more than one fraud marker. For example, a single transaction could both be bound to a suspicious payee and be a first-time international transaction from a payor (to this payee or otherwise), thus satisfying/matching two fraud markers. As another example, a payee account could have its information changed twice in a single day and changed from a domestic address to an international address (or other international account information), thus matching two fraud markers. If there is a match with more than one fraud marker, method 300 proceeds to step 316. If there is not a match with more than one fraud marker, method 300 proceeds to step 318.

Step 316 includes determining an aggregate fraud score for the more than one fraud markers. In general, the aggregate fraud score represents the likelihood that the monitored activity is fraudulent and/or the severity of the fraudulent activity. In certain embodiments, when the activity monitored matches more than one fraud marker (e.g., a series of activities or a single activity matches one or more fraud markers), an aggregate fraud score is determined. The aggregate fraud score may be determined in any suitable way and may be based, for example, on the individual fraud markers that were matched and/or the number of fraud markers matched. For example, the aggregate fraud score may be the sum of the individual fraud scores of each fraud marker that is matched to the monitored activity, with an additional value added based on the number of fraud markers matched. In other embodiments, the aggregate fraud score may be the average of the individual fraud scores, and/or the aggregate fraud score may be scaled to be within a certain range depending on the individual fraud scores and the number of individual fraud scores. The aggregate fraud score may be determined, in some embodiments, by multiplying the individual fraud scores of each fraud marker together and then scaling the product to be within a 0 to 100 point scale. In addition to these examples, any suitable means of calculating an aggregate fraud score is contemplated. The fraud score may, in some embodiments, be determined based on the same fraud scores related to the fraud markers at issue that were determined at step 306. In addition, the fraud score may be the same as the a fraud score of a group of fraud markers that was determined at step 306.

Step 318 includes determining the fraud score for the matched fraud marker. Step 318 occurs in the instance where the monitored activity matches one fraud marker. In general, the fraud score represents the likelihood that the monitored activity is fraudulent and/or the severity of the fraudulent activity. It differs from the aggregate fraud score of step 316 in that the fraud score is based on one (as opposed to multiple) fraud markers. The fraud score may, in some embodiments, be the same fraud score related to the fraud marker at issue that was determined at step 306.

Step 320 includes determining whether the fraud score (whether the fraud score of step 318 or the aggregate fraud score of step 316) is above a first threshold value. In general, the first threshold value is a value below which the monitored activity may proceed, even if it was identified by a fraud marker. For example, on a 100-point scale, a first threshold value may be 10, such that activity having a fraud score of a 9 is permitted, but activity having a fraud score of 10 or 11 is not immediately permitted. If the fraud score is below the first threshold value, method 300 proceeds to step 322. If the fraud score is at or above the first threshold value, method 300 proceeds to step 324. Any suitable first threshold value, or no first threshold value is contemplated, calculated in any suitable manner.

Step 322 includes allowing the monitored activity. In certain embodiments, the activity at issue may be permitted to occur/continue. For example, a transaction is allowed (e.g., not hindered by an the enterprise monitoring the activity), or a change to a payee or payor account is allowed.

Step 324 includes determining whether to block, cancel, or hold the monitored activity. In some embodiments, the activity identified by the one or more fraud markers is not immediately permitted because its (aggregate) fraud score is at or greater than the first threshold value. In such instances and in certain embodiments, a decision is then made as to what to do regarding the activity. One option is to block the activity, e.g., to prevent the activity from occurring or from completing, such as terminating the activity. In some embodiments, blocking the activity may include blocking similar activity or all activity of or affecting the relevant payee or payor's account. Another option is to cancel the activity, e.g., if the activity is completed, it is undone (reversed). For example, new (expected fraudulent) payee account information is entered and then this change is canceled, or a transaction is completed and then canceled. Yet another option is to place a hold on the activity, suspending the activity until further action occurs. For example, a transaction is placed on hold until it can be determined whether it is actually fraudulent. In addition to these options, any other suitable options are contemplated and can be determined in any suitable manner.

The determination of which option (e.g., blocking, canceling, or placing the activity on hold) may be made by any suitable means. For example, rules based on the type of activity identified by the fraud marker(s) may determine which option is chosen. Rules based on the fraud score of the activity may also determine which option is chosen, as may user preferences (e.g., payor preferences) regarding how the user want certain potentially fraudulent activity treated. For example, whether to institute a block, cancellation, or hold of the monitored activity is based on the fraud score. If blocking of the activity is chosen, method 300 proceeds to step 326. If cancellation of the activity is chosen, method 300 proceeds to step 328. If the activity at issue is to be placed on hold, method 300 proceeds to step 332.

Step 326 includes blocking the activity identified by the one or more fraud markers, for example, as previously discussed. Any suitable method of blocking is contemplated.

Step 328 includes canceling the activity identified by the one or more fraud markers, for example, as previously discussed. Any suitable method of canceling is contemplated.

Step 330 includes alerting the affected payor and/or payee that the activity identified by the one or more fraud markers has been blocked and/or canceled. In certain embodiments, only the payor is notified in instances where the payee is operating in a fraudulent (or suspected fraudulent) manner. In certain embodiments, multiple accounts (including their users) are notified/alerted of the fraudulent activity as a warning or preventative measure, based, for example, on the history and/or susceptibility of the multiple accounts to fraud of the type describing the monitored activity. In some embodiments, all accounts are notified of the fraudulent activity. An enterprise may, in particular embodiments, analyze past, current, or future activity (e.g., using activity management engine 208 or any other component of system 100) that is similar to or conforms with the currently monitored (i.e., fraudulent or suspected fraudulent) activity to determine which accounts are to be notified. As just one example, if fraudulent activity is identified as a transaction to a payee account having a particular email address or domain name, then past, current, or future activity involved with that email address or domain name, such as transactions from payors to payee accounts having (including using) that email address or domain name, will be flagged and the related payor and/or payees alerted. Such activity may also be blocked, canceled, or placed on hold, in certain embodiments. Any suitable method of alerting accounts and/or users or user devices (e.g., devices 126 and 130) holding or operating (or able to access) those accounts are contemplated.

Step 332 includes placing a hold on the activity identified by the one or more fraud markers, for example, as previously discussed. Any suitable method of holding the activity is contemplated.

Step 334 includes determining whether the fraud score (or the aggregate fraud score) is above a second threshold value. In general, the second threshold value is a value below which the monitored activity is evaluated by an analyst rather than approved by the payor of the monitored activity that matches the one or more fraud markers. For example, on a 100-point scale, a second threshold value may be 50, such that information regarding activity having a fraud score of a 49 is sent to an analyst for evaluation, but information regarding activity having a fraud score of 50 or 51 is sent to a payor of the activity (e.g., a payor that initiated a likely fraudulent transaction with a payee). If the fraud score is at or above the second threshold value, method 300 proceeds to step 336. If the fraud score is below the second threshold value, method 300 proceeds to step 346. Any suitable second threshold value, or no second threshold value is contemplated, calculated in any suitable manner. In some embodiments, the fraud markers at issue may not identify a particular payor (e.g., a payee modifying its account information in a way indicating fraud). In such instances, method 300 may proceed to step 346, according to certain embodiments.

Step 336 includes notifying a payor affected or potentially affected the fraudulent (or potentially fraudulent) activity that the activity is or may be fraudulent, and seeking approval from the payor for permitting the activity to occur/continue. Any suitable method for notifying the payor and obtaining approval (or not obtaining approval) is contemplated. For example, an application on a mobile device of (or used by) a user of the payor account may be sent and display a notification message seeking approval for a flagged transaction (potentially activity).

Step 338 includes determining whether the payor of step 336 gave approval for the activity to occur/continue. For example, this step may include receiving a message from the user, the user's mobile device, the payor's account (or by any other means) where the message indicates that the activity may (or may not) occur. In some embodiments, a time-out may be used such that if no response is received within a certain time (e.g., a day or any other suitable time), the activity is blocked or canceled, as appropriate. If the payor gives approval for the activity to occur/continue, method 300 proceeds to step 340. If the payor does not give approval for the activity to occur/continue, method 300 proceeds to step 342.

Step 340 includes allowing the monitored activity. In certain embodiments, the activity at issue may be permitted to occur/continue. For example, a transaction is allowed (e.g., not hindered by an the enterprise monitoring the activity), or a change to a payee or payor account is allowed. Allowing activity at this or any step can be done by any suitable means, such as sending a message indicating that the activity may be allowed, determining that no action should be taken to impede the activity, etc.

Step 342 includes blocking or canceling the monitored activity, as appropriate. In general, the activity is blocked or canceled if the payor of step 336 does not approve the suspicious activity. Blocking or canceling may occur as described previously in this method (e.g., as described regarding steps 324-328).

Step 344 includes alerting the affected payor and/or payee that the activity identified by the one or more fraud markers has been blocked and/or canceled. In certain embodiments, only the payor is notified in instances where the payee is operating in a fraudulent (or suspected fraudulent) manner. In certain embodiments, multiple accounts (including users thereof) are notified/alerted of the fraudulent activity as a warning or preventative measure, based, for example, on the history and/or susceptibility of the multiple accounts to fraud of the type of the monitored activity. In some embodiments, all accounts are notified of the fraudulent activity. An enterprise may, in particular embodiments, analyze past activity that is similar to or conforms with the currently monitored (i.e., fraudulent or likely fraudulent) activity to determine which accounts should be notified. Any suitable method of alerting accounts and/or users of those accounts are contemplated.

Step 346 includes sending information regarding to the monitored activity at issue to an analyst. In general, method 300 proceeds to step 346 when the fraud score (or aggregate fraud score) of the monitored activity at issue is above the second threshold value, as discussed at step 334. In certain embodiment, step 346 includes sending information regarding the activity at issue to a human analyst, though in other embodiments the analyst may be software configured to determine the level of threat posed by the (potentially) fraudulent activity.

Step 348 includes analyzing the activity (e.g., the information regarding the activity sent at step 346) to determine if the activity is fraudulent. In some embodiments, the human or software analyst may determine the level of threat posed by the (potentially) fraudulent activity. Whether the activity is fraudulent may be determined by any suitable procedure, and may include applying rules based on past experiences with similar activity and/or payees of (or affected by) the activity at issue.

Step 350 includes determining whether the activity is fraudulent, for example, by obtaining a result from step 348. If the activity is fraudulent, method 300 proceeds to step 342 and the activity is blocked or canceled. If the activity is not fraudulent, method 300 proceeds to step 340 and the activity is permitted to occur/continue.

Method 300, in some embodiments, may increase the security of computer networks by increasing the ability of networks, enterprises, payors, and administrators to detect fraud, and especially fraud initiated by payees. More specifically, embodiments of method 300 target, detect, and/or prevent payee fraud induced by phishing scams and ploys. In addition, by increasing network security (including the security of individual accounts associated with the network), networks may function more for their intended purposes, and the improper access and use of the network may be reduced. Implementing certain embodiments of method 300 may also mean that fewer resources, both within the network and outside of the network (e.g., by enterprises and administrators) are required to devote to identification and/or remediation of network security vulnerabilities, and particularly payee induced fraud. Moreover, enterprises providing payor accounts may not host or provide payee accounts (e.g., a payor can make a payment or otherwise send value to a remote account), and therefore such enterprises may not collect, create, or use payee information to reduce fraudulently induced transactions and other activity. Certain embodiments of method 300, however, do make use of such payee information (payee data) to detect and prevent payee induced fraud. Moreover, some embodiments transform payee information into fraud markers that can be used by computer networks and systems to increase network security by identifying potentially fraudulent activity. Thus, in sum, networks and computer systems may run more efficiently with reduced security vulnerability and reduced security incidents, and, as a result, method 300 addresses a problem necessarily rooted in computer network security systems and improves the underlying computer network security technology.

This disclosure contemplates methods, such as method 300, creating multiple (first, second, third, etc.) fraud markers based on the same or different activities. These fraud markers may be used individually or in conjunction with each other or in any other suitable manner.

Although this disclosure describes and illustrates particular steps of the method of FIG. 3 as occurring in a particular order, this disclosure contemplates any steps of the method of FIG. 3 occurring in any order. An embodiment can repeat or omit one or more steps of the method of FIG. 3. Moreover, although this disclosure describes and illustrates particular components carrying out particular steps of the method of FIG. 3, this disclosure contemplates any combination of any components carrying out any steps of the method of FIG. 3.

As used in this document, “each” refers to each member of a set or each member of a subset of a set. Furthermore, as used in the document “or” is not necessarily exclusive.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A system, comprising:
a payee data database configured to store payee data;
a fraud marker engine configured to:
determine a fraud marker based on the payee data from the payee data database, wherein the fraud marker identifies:
an activity comprising performing a transaction benefiting a payee account, wherein a plurality of payor accounts have, within a defined time frame, changed their intended payee information to include the payee account; and
the payee data comprises the intended payee information of each of the plurality of payor accounts;
a fraud marker scoring engine configured to:
determine a fraud score for the fraud marker based on at least one of a likelihood that the activity is fraudulent and a severity of the activity;
an activity monitoring and matching engine configured to:
monitor activity of at least one of a first payee account and a first payor account;
determine that the monitored activity matches the fraud marker; and
institute, on the monitored activity, based on the fraud score, at least one of:
a block, comprising terminating the monitored activity, wherein the monitored activity is not yet completed;
a cancellation, comprising reversing the monitored activity, wherein the monitored activity is completed; and
a hold, comprising suspending the monitored activity.

2. The system of claim 1, wherein:
the monitored activity is of the first payor account;
the first payor account is operated by a first payor; and
the activity monitoring and matching engine is further configured to:
send an alert to the first payor indicating that the monitored activity has been identified as a fraud risk; and
send an alert to a second payor operating a second account based on whether the second account has engaged in past activity that matches the fraud marker.

3. The system of claim 1, wherein instituting at least one of the block, the cancellation, and the hold of the monitored activity based on the fraud score further comprises determining that the fraud score is above a threshold value.

4. The system of claim 1, wherein
the monitored activity is of the first payor account;
the first payor account is operated by a first payor; and
the activity monitoring and matching engine is further configured to, in the event the hold is instituted:
determine that the fraud score is above a threshold value;
send a notification to the first payor seeking approval for the monitored activity;
receive a response from the first payor indicating approval for the monitored activity; and
allow the monitored activity.

5. The system of claim 1, wherein
the fraud marker engine is further configured to determine a second fraud marker based on second payee data, wherein the second fraud marker identifies a second activity comprising performing a second transaction between a second payor account and a second payee account, wherein:
the second transaction is the first time any transaction has occurred from the second payor account to the second payee account; and
the second payee data indicates that the second payee account is based in a second country, wherein the second country is different from a first country in which the payor account is based; and
the fraud marker scoring engine is further configured to determine a second fraud score for the second fraud marker based on at least one of a likelihood that the second activity is fraudulent and a severity of the second activity.

6. The system of claim 1, wherein:
the fraud marker engine is further configured to determine a second fraud marker based on second payee data, wherein the second fraud marker identifies a second activity comprising modifying the second payee data by changing domestic information of the second payee data to international information; and
the fraud marker scoring engine is further configured to determine a second fraud score for the second fraud marker based on at least one of a likelihood that the second activity is fraudulent and a severity of the second activity.

7. The system of claim 1, wherein:
the fraud marker engine is further configured to determine a second fraud marker based on second payee data, wherein the second fraud marker identifies a second activity comprising performing a second transaction between a second payor account and a second payee account, wherein information about the second transaction provided by the second payee account does not match information about the second transaction provided by the second payor account; and
the fraud marker scoring engine is further configured to determine a second fraud score for the second fraud marker based on at least one of a likelihood that the second activity is fraudulent and a severity of the second activity.

8. A system, comprising:
a fraud marker engine configured to:
determine a fraud marker based on payee data, wherein the fraud marker identifies:
an activity comprising performing a transaction benefiting a payee account, wherein a plurality of payor accounts have, within a defined time frame, changed their intended payee information to include the payee account; and
the payee data comprises the intended payee information of each of the plurality of payor accounts;
a fraud marker scoring engine configured to:
determine a fraud score for the fraud marker based on at least one of a likelihood that the activity is fraudulent and a severity of the activity;
an activity monitoring and matching engine configured to:
monitor activity of at least one of a first payee account and a first payor account;
determine that the monitored activity matches the fraud marker; and
institute, on the monitored activity, based on the fraud score, at least one of:
a block, comprising terminating the monitored activity, wherein the monitored activity is not yet completed;
a cancellation, comprising reversing the monitored activity,
wherein the monitored activity is completed; and
a hold, comprising suspending the monitored activity.

9. The system of claim 8, wherein:
the monitored activity is of the first payor account;
the first payor account is operated by a first payor; and
the activity monitoring and matching engine is further configured to:
send an alert to the first payor indicating that the monitored activity has been identified as a fraud risk; and
send an alert to a second payor operating a second account based on whether the second account has engaged in past activity that matches the fraud marker.

10. The system of claim 8, wherein instituting at least one of the block, the cancellation, and the hold of the monitored activity based on the fraud score further comprises determining that the fraud score is above a threshold value.

11. The system of claim 8, wherein
the monitored activity is of the first payor account;
the first payor account is operated by a first payor; and
the activity monitoring and matching engine is further configured to, in the event the hold is instituted:
determine that the fraud score is above a threshold value;
send a notification to the first payor seeking approval for the monitored activity;
receive a response from the first payor indicating approval for the monitored activity; and
allow the monitored activity.

12. The system of claim 8, wherein
the fraud marker engine is further configured to:
determine a second fraud marker based on second payee data, wherein the second fraud marker identifies a second activity comprising performing a second transaction between a second payor account and a second payee account, wherein:
the second transaction is the first time any transaction has occurred from the second payor account to the second payee account; and
the second payee data indicates that the second payee account is based in a second country, wherein the second country is different from a first country in which the payor account is based; and
the fraud marker scoring engine is further configured to determine a second fraud score for the second fraud marker based on at least one of a likelihood that the second activity is fraudulent and a severity of the second activity.

13. The system of claim 8, wherein:
the fraud marker engine is further configured to determine a second fraud marker based on second payee data, wherein the second fraud marker identifies a second activity comprising modifying the second payee data by changing domestic information of the second payee data to international information; and
the fraud marker scoring engine is further configured to determine a second fraud score for the second fraud marker based on at least one of a likelihood that the second activity is fraudulent and a severity of the second activity.

14. The system of claim 8, wherein:
the fraud marker engine is further configured to determine a second fraud marker based on second payee data, wherein the second fraud marker identifies a second activity comprising performing a second transaction between a second payor account and a second payee account, wherein information about the second transaction provided by the second payee account does not match information about the second transaction provided by the second payor account; and
the fraud marker scoring engine is further configured to determine a second fraud score for the second fraud marker based on at least one of a likelihood that the second activity is fraudulent and a severity of the second activity.

15. A method, comprising:
determining a fraud marker based on payee data, wherein the fraud marker identifies:
an activity comprising performing a transaction benefiting a payee account, wherein a plurality of payor accounts have, within a defined time frame, changed their intended payee information to include the payee account; and
the payee data comprises the intended payee information of each of the plurality of payor accounts;
determining a fraud score for the fraud marker based on at least one of a likelihood that the activity is fraudulent and a severity of the activity;
monitoring activity of at least one of a first payee account and a first payor account;
determining that the monitored activity matches the fraud marker; and
instituting, on the monitored activity, based on the fraud score, at least one of:
a block, comprising terminating the monitored activity, wherein the monitored activity is not yet completed;
a cancellation, comprising reversing the monitored activity, wherein
the monitored activity is completed; and
a hold, comprising suspending the monitored activity.

16. The method of claim 15, wherein:
the monitored activity is of the first payor account;
the first payor account is operated by a first payor; and
the method further comprises:
sending an alert to the first payor indicating that the monitored activity has been identified as a fraud risk; and
sending an alert to a second payor operating a second account based on whether the second account has engaged in past activity that matches the fraud marker.

17. The method of claim 15, wherein instituting at least one of the block, the cancellation, and the hold of the monitored activity based on the fraud score further comprises determining that the fraud score is above a threshold value.

18. The method of claim 15, wherein
the monitored activity is of the first payor account;
the first payor account is operated by a first payor; and
the method further comprises, in the event the hold is instituted:
determining that the fraud score is above a threshold value;
sending a notification to the first payor seeking approval for the monitored activity;
receiving a response from the first payor indicating approval for the monitored activity; and
allowing the monitored activity.

19. The method of claim 15, further comprising:
determining a second fraud marker based on second payee data, wherein the second fraud marker identifies a second activity comprising performing a second transaction between a second payor account and a second payee account, wherein:
the second transaction is the first time any transaction has occurred from the second payor account to the second payee account; and
the second payee data indicates that the second payee account is based in a second country, wherein the second country is different from a first country in which the payor account is based; and
determining a second fraud score for the second fraud marker based on at least one of a likelihood that the second activity is fraudulent and a severity of the second activity.

20. The method of claim 15, further comprising:
determining a second fraud marker based on second payee data, wherein the second fraud marker identifies a second activity comprising modifying the second payee data by changing domestic information of the second payee data to international information; and
determining a second fraud score for the second fraud marker based on at least one of a likelihood that the second activity is fraudulent and a severity of the second activity.
